(19) United States
(12) Patent Application Publication
(10) Pub. No.: US 2026/0172660 A1
(43) Pub. Date: Jun. 18, 2026

(54) Video Surveillance Device Capable of Multi-Angle Monitoring

(71) Applicant: Guizhou Power Grid Co., Ltd., Guiyang (CN)

(72) Inventors: Yang QIN, Guiyang (CN); Xi FANG, Guiyang (CN); Xianyue LUO, Guiyang (CN); Shuai WANG, Guiyang (CN); Lei HUANG, Guiyang (CN); Jingyu ZHOU, Guiyang (CN); Ziya ZHOU, Guiyang (CN); Xiankan LIN, Guiyang (CN); Xianglan WANG, Guiyang (CN); Yuxiao ZHANG, Guiyang (CN); Legui ZHAN, Guiyang (CN); Qun YU, Guiyang (CN); Chen YANG, Guiyang (CN); Qiangfei ZHAO, Guiyang (CN); Jing LI, Guiyang (CN); Xiaokang ZHOU, Guiyang (CN); Qinghe YANG, Guiyang (CN); Dan JIANG, Guiyang (CN); Longqiang WANG, Guiyang (CN); Yuefeng PENG, Guiyang (CN); Zhongtao LI, Guiyang (CN); Yaqiang MO, Guiyang (CN); Fei XIE, Guiyang (CN); Zheng LONG, Guiyang (CN); Hui ZHAO, Guiyang (CN); Ting HUANG, Guiyang (CN); Maoshun YAO, Guiyang (CN); Junwen LONG, Guiyang (CN); Hui YANG, Guiyang (CN); Zhimin AO, Guiyang (CN); Qian XIAO, Guiyang (CN); Xiyu CHEN, Guiyang (CN)

(21) Appl. No.: 19/170,484

(22) Filed: Apr. 4, 2025

(30) Foreign Application Priority Data
Dec. 17, 2024 (CN) 202411859577.8

(51) Int. Cl. H04N 23/54; H04N 7/18; H04N 23/52; H04N 23/695

(52) U.S. Cl. CPC H04N 23/54; H04N 7/18; H04N 23/52; H04N 23/695

(57) ABSTRACT

The present invention relates to the technical field of video surveillance, in particular to a video surveillance device capable of multi-angle monitoring. The video surveillance device comprises a fixing mechanism, an angle adjustment mechanism, a monitoring case, a rotating rod, a monitoring camera, a mounting mechanism, a driving mechanism, a cleaning mechanism, and a blowing mechanism, where the fixing mechanism comprises a support leg and a column. The present invention can adjust the monitoring angle of the monitoring case and clean the monitoring camera, and the driving mechanism drives the cleaning mechanism to move back and forth and drives the blowing mechanism to blow air.

### CROSS-REFERENCE TO RELATED APPLICATIONS

The present application claims priority to Chinese Patent Application No. 202411859577.8, filed on Dec. 17, 2024, the entire disclosure of which is incorporated herein by reference.

### TECHNICAL FIELD

The present invention relates to the technical field of video surveillance, in particular to a video surveillance device capable of multi-angle monitoring.

### BACKGROUND

In today's society, video surveillance systems play a crucial role in many fields, such as urban security monitoring, industrial production monitoring, traffic condition monitoring, and security assurance in various public places. With increasingly complex and diverse application scenarios, the requirements for the functions of video surveillance devices are constantly improving, especially in the two key aspects of camera shooting angle coverage and lens cleanliness to ensure shooting quality.

Existing video surveillance devices mostly have a camera structure mounted at a fixed angle, with a very limited monitoring area and a large number of visual blind areas. Although some existing surveillance devices are equipped with adjustable angle pan-tilt structures, these pan-tilt adjustment structures can only simply rotate horizontally or be adjusted within a small range of pitch angle, so the range of adjustment angle is relatively narrow;

Secondly, in actual usage environments, video surveillance devices are usually exposed to the outside for a long time and are inevitably affected by dust, sandstorm, haze, and other pollutants. Impurities such as dust gradually accumulate over time on the outer side of the camera, especially on the surface of the lens, which seriously affects the clarity and visibility of captured images. Existing methods for cleaning cameras are mainly manual regular cleaning, which requires specialized maintenance personnel to wipe and clean each camera on site. This not only requires huge workload and high cost, but also poses significant safety risks for some cameras mounted at high places and difficult to reach. Meanwhile, the period of manual cleaning is often difficult to accurately control. If not cleaned in a timely manner, the camera may be in a blurry shooting state for a long time, which affects the monitoring effect. Therefore, a video surveillance device capable of multi-angle monitoring is proposed.

### SUMMARY

In view of the problem of difficult cleaning of monitoring cameras in the above or existing technologies, the present invention is proposed.

Therefore, the objective of the present invention is to provide a video surveillance device capable of multi-angle monitoring.

To solve the above technical problems, the present invention provides the following technical solution: A video surveillance device capable of multi-angle monitoring includes a fixing mechanism, an angle adjustment mechanism mounted on the fixing mechanism, a monitoring case mounted on the angle adjustment mechanism, a rotating rod and a monitoring camera mounted on the monitoring case, a mounting mechanism mounted on the side of the surface of the monitoring case near the monitoring camera, a driving mechanism mounted on the mounting mechanism, as well as a cleaning mechanism and a blowing mechanism mounted at output ends of two sides of the driving mechanism respectively, where both the cleaning mechanism and the blowing mechanism face the monitoring camera.

As a preferred solution for the video surveillance device capable of multi-angle monitoring according to the present invention, the fixing mechanism includes a support leg, a column is mounted on a top outer wall of the support leg, a crossbar is mounted on a top outer wall of the column, and the angle adjustment mechanism is mounted on a bottom outer wall of the crossbar.

As a preferred solution for the video surveillance device capable of multi-angle monitoring according to the present invention, fixing stands are fixedly mounted on two sides of the bottom outer wall of the crossbar near the angle adjustment mechanism, fixing rings are mounted on bottom outer walls of the two fixing stands, and the monitoring case is located inside the fixing rings.

As a preferred solution for the video surveillance device capable of multi-angle monitoring according to the present invention, the angle adjustment mechanism includes a connecting seat, the connecting seat is mounted on the bottom outer wall of the crossbar, a first motor is mounted on a bottom outer wall of the connecting seat, a circular rod is mounted at one end of an output shaft of the first motor, a folding plate is mounted at one end of the circular rod, a rotating seat is mounted on the folding plate, a first connecting rod is mounted at one end of the rotating seat, and the monitoring case is mounted at one end of the first connecting rod.

As a preferred solution for the video surveillance device capable of multi-angle monitoring according to the present invention, the mounting mechanism includes a first mounting block and a second mounting block, the first mounting block and the second mounting block are mounted on two sides of the outer wall of the monitoring case near the monitoring camera respectively, a guide rod is mounted on an outer wall of the first mounting block, and one end of the guide rod is mounted on an outer wall of one side of the second mounting block.

As a preferred solution for the video surveillance device capable of multi-angle monitoring according to the present invention, the driving mechanism includes a second motor, the second motor is mounted on the outer wall of the second mounting block, a first output shaft and a second output shaft are provided at two ends of the second motor respectively, a screw is mounted at one end of the first output shaft of the second motor, and one end of the screw is mounted on the outer wall of the first mounting block.

As a preferred solution for the video surveillance device capable of multi-angle monitoring according to the present invention, the cleaning mechanism includes a U-shaped bracket, two ends of the U-shaped bracket are mounted on circumferential outer walls of the screw and the guide rod respectively, and a plurality of cleaning brushes are mounted inside the U-shaped bracket.

As a preferred solution for the video surveillance device capable of multi-angle monitoring according to the present invention, the blowing mechanism includes a connecting block, the connecting block is mounted on the outer wall of the second mounting block, and a second connecting rod is fixed to a surface of the connecting block.

As a preferred solution for the video surveillance device capable of multi-angle monitoring according to the present invention, a driving wheel is fitted at one end of the second output shaft of the second motor, a belt is fitted on an outer wall of the driving wheel, a driven wheel is mounted inside one end of the belt, and the driven wheel is fitted on a circumferential outer wall of the second connecting rod.

As a preferred solution for the video surveillance device capable of multi-angle monitoring according to the present invention, a mounting post is mounted on an outer wall of the driven wheel, the mounting post is rotatably fitted on the circumferential outer wall of the second connecting rod, and a plurality of spiral blades are mounted on the circumferential outer wall of the mounting post.

Beneficial effects of the video surveillance device capable of multi-angle monitoring according to the present invention are as follows: The angle adjustment mechanism can adjust the monitoring angle of the monitoring case, and the driving mechanism drives the cleaning mechanism to move back and forth and drives the blowing mechanism to blow air, thereby cleaning the monitoring camera;

The screw driven by the second motor can still rotate even when the second motor does not provide power. Under the action of wind, the wind blows the U-shaped bracket to drive the screw to rotate, so that the U-shaped bracket is blown to one side to, on the one hand, detect the wind direction, and on the other hand, to use with the angle adjustment mechanism. The angle adjustment mechanism drives the monitoring case to rotate to an appropriate angle, so that the blown U-shaped bracket is located diagonally above. After the wind weakens, the U-shaped bracket moves downward under the action of gravity. In a case of wind blowing, the monitoring camera is cleaned with the cleaning brushes to remove surface debris and facilitate the monitoring work of the monitoring camera.

If the surface of the monitoring camera is too dirty, the driving mechanism can be activated to drive the cleaning mechanism and the blowing mechanism to clean the monitoring camera.

### BRIEF DESCRIPTION OF DRAWINGS

To describe the technical solutions in embodiments of the present invention more clearly, the following briefly describes the accompanying drawings required for describing the embodiments. Apparently, the accompanying drawings in the following descriptions show merely some embodiments of the present invention, and those of ordinary skill in the art may derive other drawings from these accompanying drawings without creative efforts.

FIG. 1 is a schematic diagram of an overall structure of a video surveillance device capable of multi-angle monitoring.

FIG. 2 is a schematic structural diagram of FIG. 1 from another perspective.

FIG. 3 is a schematic diagram of a partial structure of the video surveillance device capable of multi-angle monitoring.

FIG. 4 is a schematic diagram of a partially enlarged structure of the video surveillance device capable of multi-angle monitoring.

FIG. 5 is a schematic structural diagram of FIG. 4 from another perspective.

FIG. 6 is a schematic structural diagram of a mounting mechanism, a driving mechanism, a cleaning mechanism, and a blowing mechanism of the video surveillance device capable of multi-angle monitoring.

FIG. 7 is a schematic diagram of an enlarged structure at part A in FIG. 5.

FIG. 8 is a schematic diagram of an enlarged structure at part B in FIG. 6.

### DETAILED DESCRIPTION OF THE EMBODIMENTS

In order to make the above objectives, features and advantages of the present invention more obvious and understandable, specific embodiments of the present invention will be described in detail below with reference to the accompanying drawings of the specification.

Many specific details are set forth in the following description to facilitate a full understanding of the present invention, but the present invention can also be implemented in other ways different from those described here, and those skilled in the art can do similar promotions without departing from the connotation of the present invention. Therefore, the present invention is not limited by the specific embodiments disclosed below.

Secondly, the term “one embodiment” or “embodiments” referred to here refers to specific features, structures, or features that may be included in at least one implementation of the present invention. The term “in one embodiment” appearing in different places of this specification neither necessarily refers to the same embodiment, nor is a separate or selective embodiment exclusive with other embodiments.

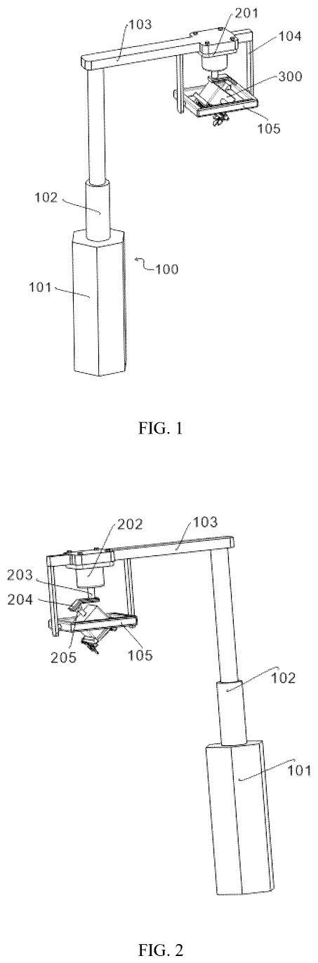

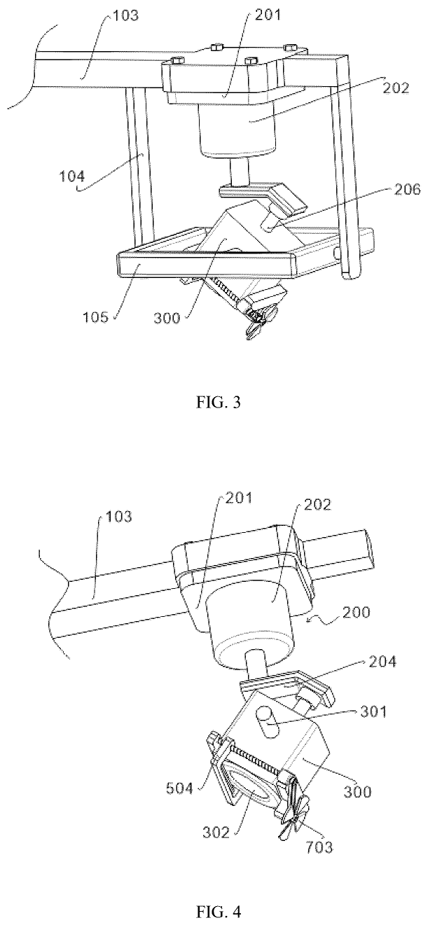

Embodiment 1 FIG. 1 to FIG. 6 show a first embodiment of the present invention. This embodiment provides a video surveillance device capable of multi-angle monitoring, including a fixing mechanism 100, an angle adjustment mechanism 200 mounted on the fixing mechanism 100, a rotating rod 301 and a monitoring case 300 mounted on the angle adjustment mechanism 200, a monitoring camera 302 mounted on the monitoring case 300, a mounting mechanism 400 mounted on the side of the surface of the monitoring case 300 near the monitoring camera 302, a driving mechanism 500 mounted on the mounting mechanism 400, as well as a cleaning mechanism 600 and a blowing mechanism 700 mounted at output ends of two sides of the driving mechanism 500 respectively, where both the cleaning mechanism 600 and the blowing mechanism 700 face the monitoring camera 302.

The fixing mechanism 100 stands on the ground, making it easy to fix the monitoring case 300 in high altitude. The angle adjustment mechanism 200 adjusts the monitoring case 300 to a suitable angle, and then the monitoring camera 302 monitors a road or other areas. If the surface of the monitoring camera 302 is not clean enough, the driving mechanism 500 drives the cleaning mechanism 600 and the blowing mechanism 700 to clean the surface of the monitoring camera 302, which facilitates subsequent monitoring using the monitoring camera 302.

Specifically, the fixing mechanism 100 includes a support leg 101, a column 102 is mounted on a top outer wall of the support leg 101, a crossbar 103 is mounted on a top outer wall of the column 102, and the angle adjustment mechanism 200 is mounted on a bottom outer wall of the crossbar 103.

Specifically, fixing stands 104 are fixedly mounted on two sides of the bottom outer wall of the crossbar 103 near the angle adjustment mechanism 200, fixing rings 105 are mounted on bottom outer walls of the two fixing stands 104, and the monitoring case 300 is located inside the fixing rings 105.

The monitoring case 300 is located inside the fixing rings 105, and the fixing rings 105 play a certain limiting role, so the rotation range of the monitoring case 300 is located inside the fixing rings 105.

Specifically, the angle adjustment mechanism 200 includes a connecting seat 201, the connecting seat 201 is mounted on the bottom outer wall of the crossbar 103, a first motor 202 is mounted on a bottom outer wall of the connecting seat 201, a circular rod 203 is mounted at one end of an output shaft of the first motor 202, a folding plate 204 is mounted at one end of the circular rod 203, a rotating seat 205 is mounted on the folding plate 204, a first connecting rod 206 is mounted at one end of the rotating seat 205, and the monitoring case 300 is mounted at one end of the first connecting rod 206.

The monitoring case 300 is mounted at one end of the folding plate 204 through the first connecting rod 206 and the rotating seat 205, so that the monitoring case 300 is at a certain tilt angle, which facilitates downward movement of the cleaning mechanism 600 due to gravity.

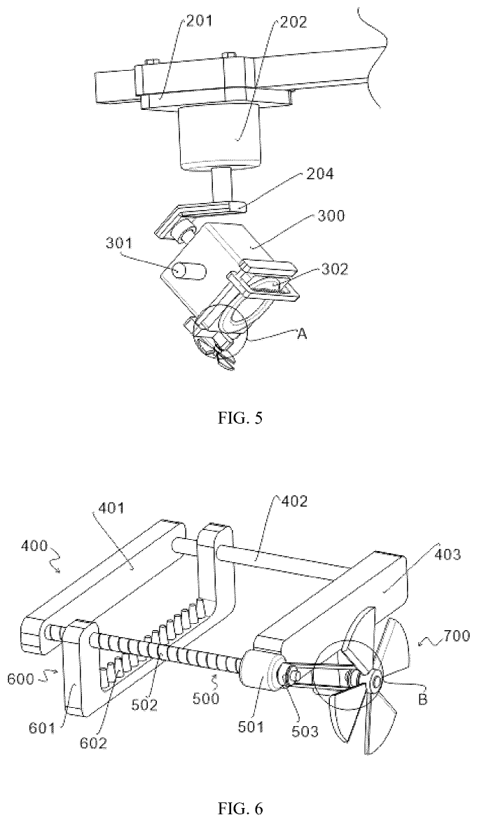

Embodiment 2 FIG. 4 and FIG. 5 show a second embodiment of the present invention. Unlike the previous embodiment, the mounting mechanism 400 includes a first mounting block 401 and a second mounting block 403, the first mounting block 401 and the second mounting block 403 are mounted on two sides of the outer wall of the monitoring case 300 near the monitoring camera 302 respectively, a guide rod 402 is mounted on an outer wall of the first mounting block 401, and one end of the guide rod 402 is mounted on an outer wall of one side of the second mounting block 403.

The first mounting block 401 and the second mounting block 403 are used for mounting the driving mechanism 500, the cleaning mechanism 600, and the blowing mechanism 700, to facilitate the mechanical structures to clean the surface of the monitoring camera 302.

Preferably, the driving mechanism 500 includes a second motor 501, the second motor 501 is mounted on the outer wall of the second mounting block 403, a first output shaft and a second output shaft are provided at two ends of the second motor 501 respectively, a screw 502 is mounted at one end of the first output shaft of the second motor 501, and one end of the screw 502 is mounted on the outer wall of the first mounting block 401.

The second motor 501 drives the screw 502 to rotate through the first output shaft, thereby driving the cleaning mechanism 600 for cleaning. The second motor 501 drives the blowing mechanism 700 through the second output shaft, thereby blowing air to the monitoring camera 302 to remove surface debris.

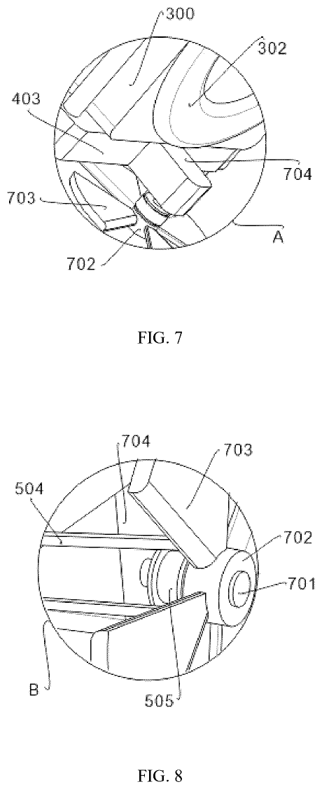

Embodiment 3 FIGS. 5-8 show a third embodiment of the present invention. Unlike the previous embodiment, the cleaning mechanism 600 includes a U-shaped bracket 601, two ends of the U-shaped bracket 601 are mounted on circumferential outer walls of the screw 502 and the guide rod 402 respectively, and a plurality of cleaning brushes 602 are mounted inside the U-shaped bracket 601.

After the second motor 501 drives the screw 502 to rotate, the U-shaped bracket 601 is driven to move back and forth, thereby cleaning the surface of the monitoring camera 302 back and forth with the cleaning brushes 602;

The screw 502 driven by the second motor 501 can still rotate even when the second motor 501 does not provide power. Under the action of wind, the wind blows the U-shaped bracket 601 to drive the screw 502 to rotate, so that the U-shaped bracket 601 is blown to one side to, on the one hand, detect the wind direction, and on the other hand, to use with the angle adjustment mechanism 200. The angle adjustment mechanism 200 drives the monitoring case 300 to rotate to an appropriate angle, so that the blown U-shaped bracket 601 is located diagonally above. After the wind weakens, the U-shaped bracket 601 moves downward under the action of gravity. In a case of wind blowing, the monitoring camera 302 is cleaned with the cleaning brushes 602 to remove surface debris and facilitate the monitoring work of the monitoring camera 302.

The blowing mechanism 700 includes a connecting block 704, the connecting block 704 is mounted on the outer wall of the second mounting block 403, and a second connecting rod 701 is fixed to a surface of the connecting block 704.

A driving wheel 503 is fitted at one end of the second output shaft of the second motor 501, a belt 504 is fitted on an outer wall of the driving wheel 503, a driven wheel 505 is mounted inside one end of the belt 504, and the driven wheel 505 is fitted on a circumferential outer wall of the second connecting rod 701.

A mounting post 702 is mounted on an outer wall of the driven wheel 505, the mounting post 702 is rotatably fitted on the circumferential outer wall of the second connecting rod 701, and a plurality of spiral blades 703 are mounted on the circumferential outer wall of the mounting post 702.

The second output shaft of the second motor 501 rotates, which in turn drives the driving wheel 503 to rotate, thereby driving the driven wheel 505 to rotate through the belt 504. The driven wheel 505 drives the mounting post 702 to rotate, which in turn drives the spiral blades 703 to rotate, thereby blowing air by the spiral blades 703.

It should be noted that the above embodiments are merely used for illustrating, but not limiting, the technical solutions of the present invention. Although the present invention is described in detail with reference to preferred embodiments, those of ordinary skill in the art should understand that the technical solutions of the present invention can be modified or equivalently substituted without departing from the spirit and scope of the technical solutions of the present invention, and all the modifications and equivalent substitutions should fall within the scope of the claims of the present invention.

What is claimed is:

1. A video surveillance device capable of multi-angle monitoring, comprising a fixing mechanism, an angle adjustment mechanism mounted on the fixing mechanism, a monitoring case mounted on the angle adjustment mechanism, a rotating rod and a monitoring camera mounted on the monitoring case, a mounting mechanism mounted on the side of the surface of the monitoring case near the monitoring camera, a driving mechanism mounted on the mounting mechanism, as well as a cleaning mechanism and a blowing mechanism mounted at output ends of two sides of the driving mechanism respectively, wherein both the cleaning mechanism and the blowing mechanism face the monitoring camera.

2. The video surveillance device capable of multi-angle monitoring according to claim 1, wherein the fixing mechanism comprises a support leg, a column is mounted on a top outer wall of the support leg, a crossbar is mounted on a top outer wall of the column, and the angle adjustment mechanism is mounted on a bottom outer wall of the crossbar.

3. The video surveillance device capable of multi-angle monitoring according to claim 2, wherein fixing stands are fixedly mounted on two sides of the bottom outer wall of the crossbar near the angle adjustment mechanism, fixing rings are mounted on bottom outer walls of the two fixing stands, and the monitoring case is located inside the fixing rings.

4. The video surveillance device capable of multi-angle monitoring according to claim 3, wherein the angle adjustment mechanism comprises a connecting seat, the connecting seat is mounted on the bottom outer wall of the crossbar, a first motor is mounted on a bottom outer wall of the connecting seat, a circular rod is mounted at one end of an output shaft of the first motor, a folding plate is mounted at one end of the circular rod, a rotating seat is mounted on the folding plate, a first connecting rod is mounted at one end of the rotating seat, and the monitoring case is mounted at one end of the first connecting rod.

5. The video surveillance device capable of multi-angle monitoring according to claim 4, wherein the mounting mechanism comprises a first mounting block and a second mounting block, the first mounting block and the second mounting block are mounted on two sides of the outer wall of the monitoring case near the monitoring camera respectively, a guide rod is mounted on an outer wall of the first mounting block, and one end of the guide rod is mounted on an outer wall of one side of the second mounting block.

6. The video surveillance device capable of multi-angle monitoring according to claim 5, wherein the driving mechanism comprises a second motor, the second motor is mounted on the outer wall of the second mounting block, a first output shaft and a second output shaft are provided at two ends of the second motor respectively, a screw is mounted at one end of the first output shaft of the second motor, and one end of the screw is mounted on the outer wall of the first mounting block.

7. The video surveillance device capable of multi-angle monitoring according to claim 6, wherein the cleaning mechanism comprises a U-shaped bracket, two ends of the U-shaped bracket are mounted on circumferential outer walls of the screw and the guide rod respectively, and a plurality of cleaning brushes are mounted inside the U-shaped bracket.

8. The video surveillance device capable of multi-angle monitoring according to claim 6, wherein the blowing mechanism comprises a connecting block, the connecting block is mounted on the outer wall of the second mounting block, and a second connecting rod is fixed to a surface of the connecting block.

9. The video surveillance device capable of multi-angle monitoring according to claim 8, wherein a driving wheel is fitted at one end of the second output shaft of the second motor, a belt is fitted on an outer wall of the driving wheel, a driven wheel is mounted inside one end of the belt, and the driven wheel is fitted on a circumferential outer wall of the second connecting rod.

10. The video surveillance device capable of multi-angle monitoring according to claim 9, wherein a mounting post is mounted on an outer wall of the driven wheel, the mounting post is rotatably fitted on the circumferential outer wall of the second connecting rod, and a plurality of spiral blades are mounted on the circumferential outer wall of the mounting post.
